(19) United States
(12) Patent Application Publication
(10) Pub. No.: US 2023/0302779 A1
(43) Pub. Date: Sep. 28, 2023

(54) SURFACING FILM

(71) Applicant: 3M INNOVATIVE PROPERTIES COMPANY, St. Paul, MN (US)

(72) Inventors: Yongshang LU, Woodbury, MN (US); Charlie Chia-tie HO, Woodbury, MN (US)

(21) Appl. No.: 18/041,288

(22) PCT Filed: Jul. 19, 2021
(86) PCT No.: PCT/IB2021/056513

§ 371 Date: Feb. 10, 2023

Related U.S. Application Data
(60) Provisional application No. 63/063,617, filed on Aug. 10, 2020.

(51) Int. Cl. B32B 27/40; B32B 27/08; B32B 27/36

(52) U.S. Cl. CPC B32B 27/40; B32B 27/08; B32B 27/36; B32B 2255/26; B32B 2255/10; B32B 2250/24

(57) ABSTRACT

A surfacing film is provided that includes a plurality of layers in the following order: an outer layer comprised of a reaction product of a two-part curable fluoropolyurethane composition including a polyisocyanate and at least one polyhydroxy-functional fluoropolymer, optionally a primer layer comprising a polyurethane; and a base layer. Advantageously, the surfacing films can display superior gloss, mechanical durability, chemical/stain resistance, easy cleaning performance, and weather aging stability compared with conventional surfacing films.

### FIELD OF THE INVENTION

Provided herein are surfacing films for exterior applications. The provided films can be useful, for example, in paint protection or paint replacement applications for automotive and aerospace exteriors.

### BACKGROUND

Surfacing films are applied to surfaces and protect underlying substrates from damage caused by weathering, chemical exposure, heat, and/or abrasion. These films can be used to protect either painted or unpainted surfaces. When applied to a painted surface, they are commonly referred to as paint protection films. When applied to unpainted surfaces, they can be used to provide color, in which case they may be referred to as body color film or paint replacement film.

Films made from polyurethane can withstand harsh environments, making them suitable for these applications. Polyurethanes are synthetic polymers of great commercial and industrial importance. They are commonly prepared by reacting a multifunctional isocyanate with a multifunctional diol or polyol in the presence of a catalyst to produce polymers containing carbamate (—NH—CO—O—) linkages. Thermoplastic polyurethanes are characterized by linear polymeric chains having self-ordering block structures, while thermoset polyurethanes are highly crosslinked by covalent bonds. Depending on the components used to make the polyurethane, these materials can be engineered to display a high degree of chemical resistance and a wide range of material properties. Polyurethanes can be also extremely durable and flexible.

Conventional paint replacement films include those based on polyvinyl chloride (PVC). Besides pure PVC films, PVC films with a top coat are also known, where the top coat can help improve weatherability, chemical resistance and durability. Known top coats are relatively hard, with the consequence that they cannot tolerate being significantly stretched. Over time, this can lead to cracking of the top coat in outdoor environments.

There is generally a desire, because of environmental concerns, to reduce the amount of PVC in these products. There is also a need to provide paint replacement films, especially for vehicles, with good stretchability, along with chemical resistance and weatherability close to those of paint.

### SUMMARY

Described herein are surfacing films that include a fluoropolyurethane outer layer disposed on a polymeric base layer, with an adhesive disposed on a bottom surface of the base layer opposite the fluoropolyurethane outer layer. Optionally, a primer layer can be disposed between the fluoropolymer-based polyurethane layer and the elastomeric polymer film. For paint replacement film applications, this primer layer can be pigmented. Compared with conventional surfacing films, these surfacing films can display superior gloss, mechanical durability, chemical/stain resistance, easy cleaning performance, and weather aging stability.

In a first aspect, a surfacing film is provided. The surfacing film comprises a plurality of layers in the following order: an outer layer comprised of a reaction product of a two-part curable fluoropolyurethane composition including a secondary polyisocyanate and at least one polyhydroxy-functional fluoropolymer; optionally, a primer layer comprising a polyurethane; and a base layer.

In a second aspect, a process of making a surfacing film is provided, comprising: initiating a curing reaction between a secondary polyisocyanate and a hydroxy-functional fluoropolymer to provide an outer layer of the surfacing film; optionally, disposing onto the outer layer a primer layer comprising a polyurethane; and disposing onto either the outer layer or the primer layer a base layer, wherein the outer layer is less than functionally cured when the base layer or the primer layer is disposed thereon.

### BRIEF DESCRIPTION OF THE DRAWINGS

FIGS. 1 and 2 are elevational cross-sectional side views of surfacing films according to two exemplary embodiments.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DEFINITIONS

“Amino” refers to a chemical group containing a basic nitrogen atom with a lone pair (—NHR), and may be either a primary or secondary chemical group.

“Average” refers to a number average, unless otherwise specified.

“Cure” refers to exposing to radiation in any form, heating, or allowing to undergo a physical or chemical reaction that results in hardening or an increase in viscosity. Materials can be cured by mixing reactive components with each other, heating or exposing to actinic radiation.

“Functionally cure” refers to curing to an extent sufficient for the cured material to be used in its intended application.

“Partially cure” means curing to an extent that is measurable but insufficient for the cured material to be used in its intended application.

“Polymer” refers to a molecule having at least one repeating unit and can include copolymers.

“Substituted” as used in conjunction with a molecule or an organic group as defined herein refers to the state in which one or more hydrogen atoms contained therein are replaced by one or more non-hydrogen atoms.

“Two-part” means provided in two or more discrete components that are subsequently mixed with each other.

### DETAILED DESCRIPTION

Reference will now be made in detail to various embodiments of the disclosed subject matter. While the disclosed subject matter will be described in conjunction with the enumerated claims, it will be understood that the exemplified subject matter is not intended to limit the claims to the disclosed subject matter.

The terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for description only and not of limitation. Any use of section headings is intended to aid reading of the document and is not to be interpreted as limiting; information that is relevant to a section heading may occur within or outside of that section.

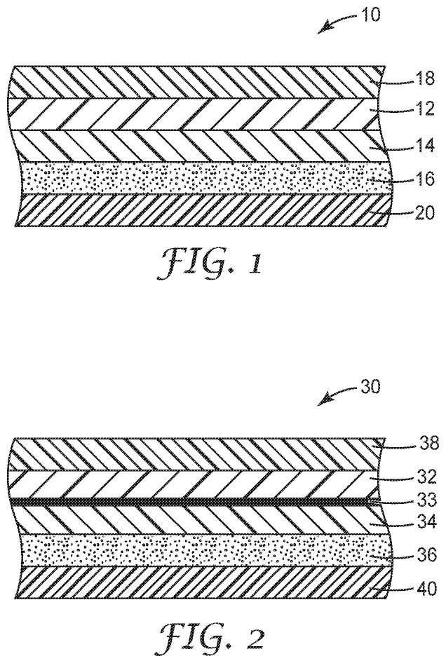

FIG. 1 illustrates a surfacing film 10. The surfacing film 10 includes an outer layer 12 and a base layer 14 disposed on the outer layer 12. Optionally, and as further shown in FIG. 1, the surfacing film 10 can include an adhesive layer 16 disposed on the side of the base layer 14 facing away from the outer layer 12. The adhesive layer 16 can be a pressure-sensitive adhesive layer or a hot melt adhesive layer.

Other optional layers shown in FIG. 1 include a release liner 18 that is releasably bonded to the side of the outer layer 12 facing away from the base layer 14. If an adhesive layer 16 is a pressure-sensitive adhesive, the surfacing film 10 could also include second release liner 20 releasably bonded thereto as shown so as to cover the adhesive layer 16. The release liners 18, 20 protect the underlying surfaces from damage during transport or storage, and can be removed during application.

Additional details concerning these layers are provided in the sections below.

The outer layer, present along a major surface of the surfacing film when in use, can be comprised of a polyurethane. The polyurethane is preferably a crosslinked polyurethane. In a preferred embodiment, the crosslinked polyurethane is made by reacting a two-part curable fluoropolyurethane composition. A first reactive part of the curable fluoropolyurethane composition contains one or more polyisocyanates, while a second reactive part of the curable fluoropolyurethane composition contains at least one polyhydroxy-functional fluoropolymer capable of reacting with the one or more polyisocyanates.

More particularly, the first reactive part can include a primary or secondary polyisocyanate. The primary or secondary polyisocyanates can be aliphatic polyisocyanates. Examples of a suitable polyisocyanate include diisocyanates according to Formula I below:

O═C═N—R—N═C═O Formula I.

In Formula I, R can be chosen from a substituted or unsubstituted (C1-C40)alkylene, (C2-C40)alkenylene, and (C4-C20)cycloalkylene. In further examples, the diisocyanate can include dicyclohexylmethane-4,4′-diisocyanate, isophorone diisocyanate, hexamethylene diisocyanate, poly(hexamethylene diisocyanate), 1,4-cyclohexylene diisocyanate, hexamethylene diisocyanate, 1,4-diisocyanatobutane, 1,8-diisocyanatooctane, 1,6-diisocyanatohexane 1,12-diisocyanatododecane, 2-methyl-1,5 -diisocyanatopentane, methylenedicyclohexylene-4,4′-diisocyanate, 3-isocyanatomethyl-3,5,5-trimethylcyclohexyl isocyanate, 2,2,4-trimethylhexyl diisocyanate, or a mixture thereof.

Particularly suitable aliphatic polyisocyanates include primary polyisocyanates such as hexamethylene diisocyanate (HDI) trimer (Formula II), secondary polyisocyanates such as isophorone diisocyanate trimer (Formula III), HDI biurets, HDI uretdiones, and combinations thereof. Suitable polyisocyanates are commercially available under the trade designation DESMODUR from Covestro AG, Leverkusen, Germany.

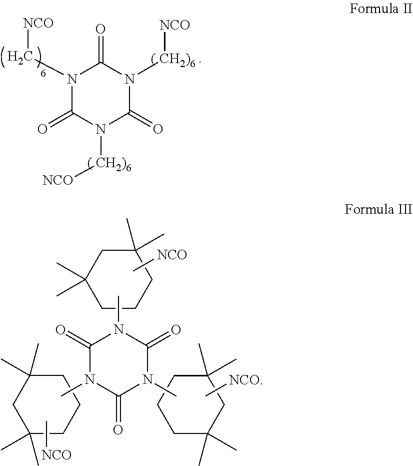

The primary or secondary polyisocyanate can be present in an amount of from 5 percent to 90 percent, 10 percent to 80 percent, 20 percent to 70 percent, or in some embodiments, less than, equal to, or greater than 5 percent, 10, 15, 20, 25, 30, 35, 40, 45, 50, 55, 60, 65, 70, 75, 80, 85, or 90 percent, relative to the overall weight of the two-part curable fluoropolyurethane composition.

The amount of the polyisocyanate in the curable fluoropolyurethane composition can be characterized based on an isocyanate index. An isocyanate index can be generally understood to refer to the ratio of the equivalent amount of isocyanate functional groups used relative to the theoretical equivalent amount of hydroxy-functional groups. The theoretical equivalent amount is equal to one equivalent isocyanate functional group per one equivalent hydroxyl group; this is an index of 1:1, or 100 (100×(actual amount used/theoretical amount used)). According to various examples, the isocyanate index of the curable fluoropolyurethane composition is in a range of from 99 to 120, 100 to 110, or less than equal to, or greater than 99, 100, 101, 102, 103, 104, 105, 106, 107, 108, 109, 110, 111, 112, 113, 114, 115, 116, 117, 118, 119, or 120.

Optionally, a blend of polyisocyanates can be used. As an example, a secondary polyisocyanate can be blended with a primary polyisocyanate such as hexamethylene diisocyanate.

In the second reactive part, hydroxy-functional fluoropolymers can include any of a number of copolymers of tetrafluoroethylene and hydrocarbon olefins that contain a reactive hydroxyl group. These copolymers can be provided in an organic solvent, such as butyl acetate, which are included in the curable fluoropolyurethane composition and later removed when the composition is cured. Examples include resins available under the trade designation ZEFFLE from Daikin Industries, Ltd., Osaka, Japan, or LUMIFLON from AGC Chemical America's, Inc., Exton, PA.

The hydroxy-functional fluoropolymer can have a hydroxy-equivalent weight of from 150 g/mol to 50,000 g/mol; from 200 g/mol to 5000 g/mol; from 250 g/mol to 3000 g/mol; or in some embodiments, less than, equal to, or greater than 150 g/mol; 200; 250; 300; 350; 400; 450; 500; 600; 700; 800; 900; 1000; 1500; 2000; 2500; 3000; 3500; 4000; 4500; 5000; 6000; 7000; 8000; 9000; 10,000; 20,000; 30,000; 40,000; or 50,000 g/mol.

To obtain a fluoropolymer having the desired hydroxy-equivalent weight, two or more fluoropolymer components may be blended together. For example, the second reactive part of the curable fluoropolyurethane composition could contain a first and second hydroxy-functional fluoropolymer, where the first hydroxy-functional fluoropolymer has a hydroxy-equivalent weight less than that of the second hydroxy-functional fluoropolymer. In this blended composition, the first hydroxy-functional fluoropolymer can have a hydroxy-equivalent weight of at most 2000 g/mol and the second hydroxy-functional fluoropolymer can have a hydroxy-equivalent weight of at least 500 g/mol.

The one or more polyhydroxy-functional fluoropolymers can be present in an amount of from 10 percent to 95 percent, 20 percent to 90 percent, 30 percent to 80 percent, or in some embodiments, less than, equal to, or greater than 10 percent, 15, 20, 25, 30, 35, 40, 45, 50, 55, 60, 65, 70, 75, 80, 85, 90, or 95 percent, relative to the overall weight of the two-part curable fluoropolyurethane composition.

The hydroxy-functional fluoropolymer can be in a range of from 43 wt % to 70 wt % of the reaction mixture, 50 wt % to 60 wt %, or less than, equal to, or greater than 43 wt %, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, or 70 wt % of the reaction mixture. The hydroxy-functional fluoropolymer can include any suitable number of hydroxyl groups. For example, the hydroxy-functional fluoropolymer can include three hydroxyl groups or even four or more hydroxyl groups.

The hydroxy-functional fluoropolymer can have an average functionality greater than 2 and thus acts as a crosslinker in the reactive mixture. More generally, the curable fluoropolyurethane composition can include reactive isocyanate-functional or hydroxy-functional components that act as crosslinkers. Examples of crosslinkers include polyhydroxy group compounds and polyisocyanate compounds. For example, the polyhydroxy compounds could include three or four hydroxy-functional groups. The polyisocyanate can include three or four cyano groups. While there are many suitable crosslinkers the curable fluoropolyurethane composition is free of an aziridine crosslinker. Crosslinkers, if present, can link together different thermoplastic polyurethane chains (e.g., intermolecular crosslink) or link together different sections of the same thermoplastic polyurethane chain (e.g., intramolecular crosslinks).

The outer layer can have a thickness in a range of from 0.005 mm to 2 mm, 0.5 mm to 1 mm, or less than, equal to, or greater than 0.005 mm, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, or 2 mm.

The base layer acts as a continuous backing for the fluorinated outer layer, and is generally made from a curable polyurethane composition that is not fluorinated. While not particularly restricted, the base layer can be made from a thermoplastic polyurethane, polyvinyl chloride, olefinic polymer, epichlorohydrin rubber, acrylate-based rubber, acrylate butadiene rubber, silicone rubber, fluorine-containing elastomer, polyether block amide, chlorosulfonated polyethylene, ethylene-vinyl acetate, or a combination thereof.

In an exemplary embodiment, the base layer is made from a thermoplastic polyurethane, such an aliphatic polyurethane. Useful thermoplastic polyurethanes include segmented polyurethanes having hard and soft segments. A hard segment generally refers to harder, less flexible polymer segment, which results from polymerization of the diisocyanate and the diol chain extender. The amount of the hard segment can be determined by calculating the total amount (in wt %) of isocyanate, chain extender, and cross-linker. That total amount is then divided by the total weight of the thermoplastic polyurethane. The hard segment can be in a range of from 30 wt % to 55 wt %, 40 wt % to 55 wt %, or in some embodiments, less than, equal to, or greater than 30 wt %, 31, 32, 33, 34, 35, 36, 37, 38, 39, 40, 41, 42, 43, 44, 45, 46, 47, 48, 49, 50, 51, 52, 53, 54, or 55 wt % of the thermoplastic polyurethane film.

Advantageously, the hard segments of the thermoplastic polyurethane self-assemble into discrete nanoscale domains, to form thermodynamic crosslinks. Under stress, such as through mechanical deformation, the hard segments can become aligned in the stress direction. This alignment coupled with the hydrogen bonding can contribute to the stiffness, elastomeric resilience, or tear resistance of the base layer.

The thermoplastic polyurethane can have a weight-average molecular weight in a range of from 80,000 g/mol to 400,000 g/mol, 80,000 g/mol to 200,000 g/mol, or equal to, less than, or greater than about, 80,000 g/mol; 85,000; 90,000; 95,000; 100,000; 105,000; 110,000; 115,000; 120,000; 125,000; 130,000; 135,000; 140,000; 145,000; 150,000; 155,000; 160,000; 165,000; 170,000; 175,000; 180,000; 185,000; 190,000; 195,000; 200,000; 205,000; 210,000; 215,000; 220,000; 225,000; 230,000; 235,000; 240,000; 245,000; 250,000; 255,000; 260,000; 265,000; 270,000; 275,000; 280,000; 285,000; 290,000; 295,000; 300,000; 305,000; 310,000; 315,000; 320,000; 325,000; 330,000; 335,000; 340,000; 345,000; 350,000; 355,000; 360,000; 365,000; 370,000; 375,000; 380,000; 385,000; 390,000; 395,000; or 400,000 g/mol.

In paint replacement film applications, it can be advantageous for the base layer to contain one or more colorants. Colorants include dyes and pigments, such as carbon black, white titanium dioxide, red pearl, blue pearl, yellow pearl, and metallic flakes. These can be present in an amount of from 1 percent to 20 percent, or in some embodiments, less than, equal to, or greater than 1 percent, 2, 3, 4, 5, 6, 7, 8, 9, 10, 11, 12, 13, 14, 15, 16, 17, 18, 19, or 20 percent of the overall weight of the base layer.

The high molecular weight of the thermoplastic polyurethane film can help to prevent discoloration of the film, at least in base layer. This is because the relatively high molecular weight of the thermoplastic polyurethane film can result from long chain length polyurethanes. The long chain length can result in base layer being relatively tightly packed or highly entangled such that a discoloring compound cannot readily penetrate base layer and cause discoloration therein. As an example, a yellowing color change of base layer that is exposed to a 10% bitumen solution for 24 hours is less than that of a corresponding protection film comprising a base layer that includes a thermoplastic polyurethane film having a weight-average molecular weight of 80,000 g/mol or less.

The base layer can have a thickness in a range of from 0.05 mm to 2 mm, 0.5 mm to 1 mm, or less than, equal to, or greater than 0.05 mm, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, or 2 mm.

The presence of the base layer enables the provided surfacing film 10 have a significant ability to stretch without breakage. This property is highly beneficial when applying the surfacing film 10 to the convex surfaces as commonly encountered in automotive exteriors. The surfacing film 10 can display an elongation to break of from 20 percent to 800 percent, or in some embodiments, less than, equal to, or greater than 20 percent, 30, 40, 50, 60, 70, 80, 90, 100, 150, 200, 250, 300, 350, 400, 450, 500, 550, 600, 650, 700, 750, or 800 percent under ambient conditions and measured using conventional methods.

The outer layer and base layer can be prepared using continuous manufacturing methods known in the art. Suitable methods include reactively extruding curable components in a twin-screw extruder or a planetary extruder. Suitable twin-screw extruders include a co-rotating-twin-screw extruder or a counter-rotating-twin-screw extruder. The components of the curable polyurethane composition (e.g., the polyisocyanates, chain extenders, and polyols) can be individually or simultaneously fed into the extruder.

When extruding a base layer based on a thermoplastic polyurethane, these methods avoid re-melting pellets comprising a thermoplastic polyurethane in the extruder. Avoiding use of pellets allows the curable polyurethane composition to be free of components necessary for pelletization such as wax processing aids or anti-sticking agents. The provided methods can help to ensure that the thermoplastic polyurethane film has a weight-average molecular weight of at least 80,000 g/mol. It is notable that pellets introduced into an extruder can be subjected to significant shear, which can shorten the thermoplastic polyurethane chains and thus reduce the weight-average molecular weight of the resulting film.

A base layer comprising a molten thermoplastic polyurethane can be formed and extruded through a die onto a carrier web as a uniform film. An example of a suitable die includes a coat hanger die. The uniform film can be further pressed by a cold roller which thermally quenches the reaction shaping the polyurethane, thereby solidifying the thermoplastic polyurethane to obtain base layer.

The extrusion methods above can occur at any suitable temperature. For example, the temperature can be in a range of from 40° C. to 230° C., 90° C. to 200° C., or less than, equal to, or greater than 40° C., 45, 50, 55, 60, 65, 70, 75, 80, 85, 90, 95, 100, 105, or 110, 115, 120, 125, 130, 135, 140, 145, 150, 155, 160, 165, 170, 175, 180, 185, 190, 195, 200, 205, 210, 215, 220, 225, or 230° C. The extrusion can occur for any suitable amount of time. For example, the extrusion can occur for a period of time ranging from 0.5 hours to 17 hours, 1 hour to 6 hours, or less than, equal to, or greater than 0.5 hours, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, or 17 hours.

To apply the adhesive layer to base layer, it can be desirable to corona treat (e.g., air- or nitrogen-corona treatment) and thermally laminate a major surface of the extruded base layer to be bonded to the adhesive layer. To accomplish this, the major surface of base layer, which is not in contact with the outer layer, is exposed and then corona treated. If a hot laminating process is used (e.g., outer layer is extruded onto a releasable carrier web or liner), the carrier web or liner can be first stripped off the outer layer.

If made separately, base layer and outer layer can be bonded together by laminating the layers at an elevated temperature and pressure. For example, one major surface of the outer layer can be cold laminated under pressure to one major surface of the extruded base layer, while at least the one major surface of the base layer is, or both base layer and the outer layer are, laminated at an elevated temperature that is sufficiently high enough to facilitate adequate bonding between outer layer and base layer. As used herein, cold laminating refers to the layers being laminated together between two nip surfaces in a room or ambient temperature environment (e.g., the layers are not kept in an intentionally heated environment during the laminating process). The nip surfaces can be two nip rollers, a stationary nip surface (e.g., a low friction surface of a flat or curved plate) and a nip roller, or two stationary nip surfaces. The laminating process can even be performed in a below ambient temperature environment (that is, the layers are intentionally cooled during the laminating process). For example, one or both of the nip surfaces can be chilled to a temperature below ambient, in order to cool the exposed major surfaces of the polyurethane layers (that is, the major surfaces the nip surfaces contact). The use of such chilled surfaces can eliminate, or at least help reduce, warping of the layers resulting from the laminating process. At the same time, the major surfaces that make contact at the interface between the polyurethane layers remain at the elevated temperature long enough to be sufficiently bonded together by the laminating pressure exerted by the nip surfaces. Such cold laminating can be accomplished by laminating the newly extruded base layer directly onto a preformed outer layer, while the base layer material still retains significant heat from the extrusion process. Outer layer can be still releasably bonded to the carrier web or liner, to provide additional structural strength.

Alternatively, one major surface of outer layer can also be bonded to one major surface of the extruded base layer by using a hot laminating process. With this process, the initial temperature of both outer layer and base layer is room temperature or at least a temperature that is too low to facilitate adequate bonding between outer layer and base layer. Then, at least the one major surface of base layer, at least the one major surface of outer layer, or the one major surfaces of both outer layer and base layer are heated to an elevated temperature that is sufficiently higher than room temperature to facilitate adequate bonding between the outer layer and base layer under the laminating pressure. With the hot laminating process, the layers are heated before or during the application of the laminating pressure. If a hot laminating process is used, a major surface of base layer can be releasably laminated to a readily releasable carrier web or liner (for example, a polyester carrier web) directly after base layer is extruded, in order to provide a fresh base layer with additional structural support.

Acceptable minimum temperatures and pressures for bonding the layers together, using either the cold or hot laminating process, have included a temperature of at least 50° C. and a pressure of at least 10.3 N/cm².

The adhesive layer, as mentioned earlier, is not particularly limited. Optionally, the adhesive layer can be made from any pressure-sensitive adhesive or hot melt adhesive appropriate for bonding to the substrate for the given application. Pressure-sensitive adhesives are capable of forming a bond to a substrate through the application of finger-pressure, which causes the adhesive to wet out on the substrate. Useful pressure-sensitive adhesives include styrenic block copolymers, including styrenic triblock and star block copolymers available under the trade designation KRATON, available from Kraton Corporation, Houston, TX. Examples of these block copolymer architectures are described in U.S. Pat. No. 4,780,367 (Lau et al.).

Hot melt adhesives include materials that are substantially non-tacky at room temperature but is capable of being heated to a viscous state to form a bond to a substrate by wetting out the substrate and subsequently cooling to form a bond. Hot melt adhesives include both thermoplastic and thermosettable materials. Examples of thermoplastic hot melt adhesives can include, but are not limited to, polyesters, urethanes (ether ester), vinyl acetate copolymers, or polyolefins. Suitable thermosettable hot melt adhesives include moisture activated adhesives, light activated adhesives, radiation activated adhesives or combinations thereof.

FIG. 2 is a sectional view of another surfacing film 30 that includes, like surfacing film 10, a first release liner 38, outer layer 32, base layer 34, pressure-sensitive adhesive layer 36, and second release liner 40 (in that order). In addition to the aforementioned layers, however, the surfacing film 30 further includes a primer layer 33 disposed between the outer layer 32 and the base layer 34. The primer layer 33 generally contains a polyurethane and assists in improving interlayer adhesion between the outer layer 32 and the base layer 34.

The primer layer 33 can be a water-borne primer layer. In some embodiments, the waterborne primer layer is based on a water-borne polyurethane dispersion. Preferred water-borne polyurethane dispersions include aliphatic polycarbonate polyurethane dispersions, such as those commercially available from Lubrizol Advanced Materials, Inc., Cleveland, OH. The dispersion can use a solvent system that includes water and one or more co-solvents. Certain co-solvents, such as diethylene glycol monomethyl ether, can be helpful to improve coating quality by reducing volatility of the dispersion.

The polyurethane dispersion can include any of a number of suitable surfactants, such as anionic surfactants. Anionic surfactants include, for example, sulfates such as sodium dodecyl sulfate, ammonium dodecyl sulfate, and sodium lauryl ether sulfate, and sulfosuccinnates such as dioctyl sodium sulfosuccinate and disodium lauryl sulfosuccinate. In waterborne coatings, these surfactants can be used in combination with co-dispersants. Co-dispersants include amino alcohols. Amino alcohols, such as 2-amino-2-methyl-1-propanol, can assist in neutralizing acid-functional resins, making them suitable for use in water-borne coatings.

The water-borne polyurethane composition can include any suitable crosslinker, such as a polyfunctional aziridine liquid crosslinker. The amount of crosslinker is not critical and can be selected to provide the desired degree of crosslinking. The amount of crosslinker can be from 0.5% to 5%, from 0.5% to 4%, from 0.5% to 3%, or in some embodiments, less than, equal to, or greater than 0.5%, 0.6, 0.7, 0.8, 0.9, 1, 1.1, 1.2, 1.5, 1.7, 2, 2.2, 2.5, 2.7, 3, 3.2, 3.5, 3.7, 4, 4.2, 4.5, 4.7, or 5% by weight relative to the overall weight of the second polyurethane composition.

Other additives such as ultraviolet (UV) light absorbers and stabilizers can also be included in any of the aforementioned polyurethane and fluoropolyurethane compositions. Stabilizers can include hindered amine light stabilizers that eliminate free radicals produced by photo-oxidation of the polymer. Advantageously, these additives can help minimize defects caused by cracking and gloss reduction in the clear coat layer.

In a preferred embodiment, the water-borne polyurethane dispersion is a polycarbonate polyurethane having a solids content of from 30 to 40 wt % and an overall solvent content of from 5 to 15 wt %.

The surfacing film 30 of FIG. 2 can be made using the conventional lamination methods previously described. Alternatively, the surfacing film 30 can be made by first initiating a curing reaction between a secondary polyisocyanate and a hydroxy-functional fluoropolymer to provide an outer layer of the surfacing film, disposing onto the outer layer a primer layer comprising a water-borne polyurethane while the outer layer is only partially cured, and then disposing onto either the outer layer or the primer layer a base layer.

Enhanced interlayer adhesion can result from the outer layer being significantly less than functionally cured when the base layer or the primer layer is disposed thereon. The outer layer can be from 30 percent to 90 percent cured, from 40 percent to 80 percent cured, from 50 percent to 70 percent cured, or in some embodiments, less than, equal to, or greater than 30 percent, 35, 40, 45, 50, 55, 60, 65, 70, 75, or 80 percent cured at its surface when the base layer or the primer layer is disposed thereon. The degree of curing can be measured using known methods, such as Fourier Transform Infrared Spectroscopy, as described in U.S. Pat. No. 7,977,402 (Madhusoodhanan et al.).

Other aspects of the surfacing film 30 are generally analogous to those of surfacing film 10 and shall not be repeated.

The provided surfacing films can be applied to many suitable substrates. Moreover, such surfacing films can be cut to precisely match the dimensions of any desired substrate. The substrate, as an example, can be a vehicle body, a window, or a portion thereof. With respect to a car, for example, a surfacing film can be sized to precisely fit a portion of a hood for a specific make and model of an automobile. In addition to a hood, surfacing films can be cut to conform to other features of an automobile such as a fender, a mirror, a door, a roof, a panel, a portion thereof.

Surfacing films can be sized to precisely fit a portion of a water vessel such as a hull (e.g., to protect the hull during beaching), a transom (e.g., to protect the transom from damage caused by water skis), or a bulwark (e.g., to prevent damage caused by lines). Additionally, surfacing films can be applied to trains or even aerospace vehicles such as an airplane or helicopter. For example, surfacing films can be applied to a blade such as a propeller blade (e.g., to protect against debris strikes such as ice), an airfoil (e.g., a wing or a helicopter blade), or a fuselage.

While neither intended to be limiting nor exhaustive, further exemplary embodiments are enumerated as follows:
1. A surfacing film comprising a plurality of layers in the following order: a fluoropolyurethane layer comprised of a reaction product of a two-part curable fluoropolyurethane composition including a polyisocyanate and at least one polyhydroxy-functional fluoropolymer; optionally, a primer layer comprising a polyurethane; a base layer; and an adhesive layer.
2. The surfacing film of embodiment 1, wherein the polyisocyanate is a secondary polyisocyanate.
3. The surfacing film of embodiment 1 or 2, wherein the primer layer comprises a waterborne polyurethane.
4. The surfacing film of any one of embodiments 1-3, wherein the at least one hydroxy-functional fluoropolymer has a hydroxy-equivalent weight of from 250 g/mol to 15000 g/mol.
5. The surfacing film of embodiment 4, wherein the at least one hydroxy-functional fluoropolymer has a hydroxy-equivalent weight of from 300 g/mol to 5000 g/mol.
6. The surfacing film of embodiment 5, wherein the at least one hydroxy-functional fluoropolymer has a hydroxy-equivalent weight of from 400 g/mol to 2000 g/mol.
7. The surfacing film of any one of embodiments 1-6, wherein the secondary polyisocyanate comprises an aliphatic polyisocyanate based on a hexamethylene diisocyanate and an isophorone diisocyanate trimer.
8. The surfacing film of any one of embodiments 1-7, wherein the two-part curable fluoropolyurethane composition further comprises a primary polyisocyanate.
9. The surfacing film of embodiment 8, wherein the primary polyisocyanate comprises hexamethylene diisocyanate.
10. The surfacing film of any one of embodiments 1-9, wherein the base layer comprises a thermoplastic polyurethane.
11. The surfacing film of embodiment 10, wherein the thermoplastic polyurethane has a hard segment content of from 10 percent to 65 percent.
12. The surfacing film of any one of embodiments 1-11, wherein the base layer further comprises from 1 percent to 20 percent of a colorant.
13. The surfacing film of any one of embodiments 1-12, wherein the adhesive layer is either a pressure sensitive adhesive layer or a hot melt adhesive layer.
14. A process of making a surfacing film comprising: initiating a curing reaction between a polyisocyanate and a hydroxy-functional fluoropolymer to provide an outer layer of the surfacing film, the outer layer comprising a fluoropolyurethane; optionally, disposing onto the outer layer a primer layer comprising a polyurethane; and disposing onto either the outer layer or the primer layer a base layer, wherein the outer layer is less than functionally cured when the base layer or the primer layer is disposed thereon.
15. The process of embodiment 14, wherein the outer layer is from 30 percent to 90 percent cured when the base layer or the primer layer is disposed thereon.

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

Sources and descriptions for selected materials used in these Examples are shown in Table 1 below.

TABLE 1
Materials

| Designa- | | |
|---|---|---|
| tion | Description | Source |
| AA | 2,4-Pentanedione available under the | Alfa Aesar, |
| | designation “Acetylacetone” | Haverhill, MA, |
| | | United States |
| BA | Ester solvent available under the | Alfa Aesar |
| | designation “Butyl Acetate” | |
| C-381 | Cellulose acetate butyrate ester with | Eastman Chemicals, |
| | medium butyryl content and low | Kingsport, TN. |
| | viscosity available under the | United States |
| | designation “CAB 381-0.1” | |
| GK570X | Hydroxyl-containing fluoropolymer in | Daikin Industries, |
| | butyl acetate with a sold content of 62% | Ltd, Osaka, Japan |
| | available under the designation ZEFFLE | |
| | GK 570X | |
| L916F | Hydroxyl-containing fluoropolymer | AGC Chemicals |
| | resin (100% solid content) available | Company, Exton, |
| | under the designation LUMIFLON | PA, United States |
| | L916F | |
| MIBK | Medium evaporating solvent available | Sigma Aldrich, St. |
| | under the designation “Methyl Isobutyl | Louis, MO, United |
| | Ketone (MIBK)” | States |
| N3390 | Aliphatic polyisocyanate available | Covestro AG, |
| | under the designation “DESMODUR | Leverkusen, |
| | N3390 BA/SN” | Germany |
| PMA | Propylene glycol monomethyl ether | Alfa Aesar |
| | acetate slow evaporating solvent | |
| | available under the designation “PM | |
| | Acetate” | |
| T-12 | Dibutyltin dilaurate DBTDL catalyst | Air Products, |
| | available under the trade designation | Allentown, PA, |
| | “DABCO T-12” | United States |
| T-292 | Liquid hindered amine light stabilizer | BASF Corporation, |
| | (HALS) available under the trade | Southfield, MI. |
| | designation “TINUVIN 292” | United States |
| T-405 | Solid triazine-based UV absorber | BASF Corporation |
| | available under the trade designation | |
| | “TINUVIN 405” | |
| TP-5001 | Silicone polyacrylate polyol resin | Evonik Industries |
| | available under the trade designation | AG, Essen, |
| | “TEGO Protect 5001” | Germany |
| U9190 | Aliphatic polycarbonate polyurethane | Alberdingky Boley, |
| | available under the designation | Inc., Greensboro, |
| | ALBERDINGK UL9190 | NC, United States |
| XP2847 | Aliphatic polyisocyanate available | Covestro AG |
| | under the trade designation | |
| | “DESMODUR XP 2847” | |
| Xylene | Aromatic hydrocarbon solvent | Azer Scientific, Inc, |
| | | Morgantown, PA. |
| | | United States |
| H₃PO₄ | Phosphoric acid 30% | MilliporeSigma |
| | | Corporation, |
| | | Burlington, MA, |
| | | United States |
| HNO₃ | Nitric Acid 1% | MilliporeSigma |
| H₂SO₄ | Sulfuric Acid 1% | MilliporeSigma |
| NaOH | Caustic soda | JT Baker, |
| | | Phillipsburg, NJ, |
| | | United States |
| CS SPF70 | Coppertone Sunscreen SPF70 | Bayer HealthCare |
| | | LLC, Whippany, |
| | | NJ, United States |
| CS SPF8 | Coppertone Sunscreen SPF70 | Bayer HealthCare |
| | | LLC, |

### Test Methods

### Stain

The adhesive-side of the sample was adhered to a standard RK8014 clear coated white painted panel available from ACT Test Panels Technologies, Hillsdale, Mich. A 2.54 cm (1 inch) diameter of a staining fluid was placed on the sample and left to age for 24 hours at 23.9° C. (75° F.). After 24 hours, the samples were cleaned with painters' naphtha (VM&P Naphtha, from Ashland Chemical Co., Covington, KY. United States). Lightness (ΔL), redness (Δa), yellowing (Δb) and total color change (ΔE) were measured before and after staining using a colorimeter. The test was conducted using a staining fluid that was prepared by mixing 50 volume % of AC-20 non-emulsified asphalt cement (Marathon Petroleum Company from Findlay, OH. United States) in unleaded gasoline. Samples were dipped into the staining fluid for ten seconds and then suspended in a ventilated hood chamber for fifteen minutes to allow the staining fluid to evaporate. The samples were cleaned with painters' naphtha.

### Chemical

A specific chemical (CS SPF8, CS SPF70, H3PO4, HN03, H2SO4, or NaOH) was placed on a sample film surfaces with a 10 mm spot size diameter. The film samples were put in oven for 30 min at 85° C. The specimens were removed from the oven and cleaned thoroughly with detergent and clear water and then dried. A numerical rating was assigned for the chemical resistance of a sample based on the observation criteria defined in Table 2.

TABLE 2
Chemical Test Observation Criteria and Rating

| | Chemical |
|---|---|
| | Resistance |
| Observation Criteria | Rating |
| Very high gloss, no noticeable defects visible on the | 5 |
| surface | |
| Very high gloss, noticeable defects visible on the surface | 4 |
| High gloss, swollen surface | 3 |
| Partially dissolved, damaged, or deglossed matte surface | 2 |
| Completely dissolved, deglossed, or delaminated surface | 1 |

### Examples 1-7 (Ex1-Ex7)

### Step 1: Blending of Coating Solutions

Coating solutions were prepared by mixing the ingredients and quantities (in grams) represented in Table 3 with a 3-blade propeller agitator from Mixer Direct of Louisville, KY. United States in a 100 mL container to form a 30% solids solution. The A ingredients were added first and thoroughly mixed, followed by the B ingredient, which was created by dissolving 2.5 grams of T-12 in 97.5 grams of AA. A and B were then mixed, and the C ingredients were added. Mixtures of the coating solutions were thoroughly agitated for 15 minutes.

TABLE 3
Coating Compositions (in grams)

| | | EX1 | EX2 | EX3 | EX4 | EX5 | EX6 | EX7 |
|---|---|---|---|---|---|---|---|---|
| A | GK570X | 25.00 | 25.00 | 25.00 | 25.00 | 25.00 | 16.75 | 0.0 |
| | L916F | 0.0 | 0.0 | 3.93 | 8.361 | 8.361 | 10.5 | 21.0 |
| | TP-5001 | 0.0 | 0.60 | 0.78 | 1.04 | 1.04 | 1.0 | 1.0 |
| | BA | 42.50 | 42.5 | 54 | 67 | 66.0 | 18 | 18.0 |
| | PMA | 0.0 | 0.0 | 0.0 | 0.0 | 0.0 | 11 | 11.0 |
| | MIBK | 0.0 | 0.0 | 0.0 | 0.0 | 0.0 | 19 | 19.0 |
| | C-381 | 0.0 | 0.0 | 0.0 | 0.0 | 0.0 | 2.2 | 2.2 |
| | T-405 | 0.0 | 0.0 | 0.0 | 0.0 | 0.0 | 0.7 | 0.7 |
| | T-292 | 0.0 | 0.0 | 0.0 | 0.0 | 0.0 | 0.35 | 0.35 |
| | Xylene | 0.0 | 0.0 | 0.0 | 0.0 | 0.0 | 20.5 | 26.75 |
| B | T-12 & AA | 0.50 5 | 0.50 | 0.50 | 0.50 | 0.50 | 0 .. 9 | 0.9 |
| C | N3390 | 7.93 | 7.93 | 9.67 | 11.26 | 0.0 | 0.0 | 0.0 |
| | XP2847 | 0.0 | 0.0 | 0.0 | 0.0 | 13.98 | 13.05 | 11.3 |

### Step 2: Application of the Coating Solutions

Example 1 -6 coating solutions were coated onto a bulk TPU layer surface of Surface Protection Film SPF6 (3M Company) using an RDS #18 Mayer bar and cured at oven for three minutes at 90° C. The resulting coating thickness was around 10 micrometers after curing. The coating solution of Example 7 was coated onto the surface of a 0.05 mm (2 mil) PET film assembled as described in U.S. Pat. No. 8,765,263 (Ho et al.) and cured in an oven for one minute at 90° C. Another layer of a NEOCRYL CX-100 (DSM Coating Resins, LLC, Wilmington, MA) crosslinked, waterborne polyurethane dispersion U9190 was coated over the coating solution and then cured at 90° C. for three minutes to create a dual layer construction, which was then laminated to the polyurethane side of the a polyurethane input film. The polyurethane input film was composed of TPU film extruded from an ESTANE CLA87A resin pellet obtained from Lubrizol of Wickliffe, OH, United States, with an acrylic pressure sensitive adhesive covered with a polyester release liner. The nip roll pressure was set at 0.28 MPa (40 psi) and the line speed was 3.7 meters/min (12 feet/min). Immediately after thermal lamination, a strip of laminate was peeled off from the adhesive liner and stretched. The waterborne polyurethane dispersion formulation was prepared by mixing 89.30 grams of U9190, 0.45 grams of T-292, 0.05 grams AMP-95 (ANGUS Chemical Company, Buffalo Grove, IL), 0.20 grams of TRITRON GR-7M (DOW Chemicals, Midland, MI), 8.5 grams of butyl carbitol (DOW Chemicals), 1.08 grams of T-405, 38.0 grams of de-ionized water, and 1.78 grams of NEOCRYL CX-100.

Chemical testing was performed for EX1-EX7, and the results are represented in Table 4. Stain testing was performed for EX5-EX7, and the results are represented in Table 4.

TABLE 4
Stain and Chemical Test Results

| | | Chemical | | | | | |
|---|---|---|---|---|---|---|---|
| | | CS | CS | | | | |
| | Stain | SPF8 | SPF70 | H₃PO₄ | HNO₃ | H₂SO₄ | NaOH |
| EX1 | DNT | 2 | 1 | 5 | 3 | 3 | 4 |
| EX2 | DNT | 2 | 2 | 5 | 5 | 3 | 5 |
| EX3 | DNT | 3 | 2 | 5 | 3 | 4 | 3 |
| EX4 | DNT | 3 | 2 | 5 | 3 | 4 | 3 |
| EX5 | ΔE = 0.05 | 4 | 3 | 5 | 5 | 5 | 5 |
| | ΔL = 0.01 | | | | | | |
| | Δa = 0.04 | | | | | | |
| | Δb = 0.03 | | | | | | |
| EX6 | ΔE = 0.35 | 4 | 4 | 5 | 5 | 5 | 5 |
| | AL = 0.09 | | | | | | |
| | Δa = 0.09 | | | | | | |
| | Δb = 0.32 | | | | | | |
| EX7 | ΔE = 0.14 | 4 | 4 | 5 | 5 | 5 | 5 |
| | ΔL = 0.08 | | | | | | |
| | Δa = 0.04 | | | | | | |
| | Δb = 0.12 | | | | | | |

DNT—Indicates Did Not Test

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A surfacing film comprising a plurality of layers in the following order:
a fluoropolyurethane layer comprised of a reaction product of a two-part curable fluoropolyurethane composition including a polyisocyanate and at least one polyhydroxy-functional fluoropolymer;
optionally, a primer layer comprising a polyurethane;
a base layer; and
an adhesive layer.

2. The surfacing film of claim 1, wherein the polyisocyanate is a secondary polyisocyanate.

3. The surfacing film of claim 1, wherein the primer layer comprises a waterborne polyurethane.

4. The surfacing film of claim 1, wherein the at least one hydroxy-functional fluoropolymer has a hydroxy-equivalent weight of from 250 g/mol to 15000 g/mol.

5. The surfacing film of claim 4, wherein the at least one hydroxy-functional fluoropolymer has a hydroxy-equivalent weight of from 300 g/mol to 5000 g/mol.

6. The surfacing film of claim 5, wherein the at least one hydroxy-functional fluoropolymer has a hydroxy-equivalent weight of from 400 g/mol to 2000 g/mol.

7. The surfacing film of claim 1, wherein the secondary polyisocyanate comprises an aliphatic polyisocyanate based on a hexamethylene diisocyanate and an isophorone diisocyanate trimer.

8. The surfacing film of claim 1, wherein the two-part curable fluoropolyurethane composition further comprises a primary polyisocyanate.

9. The surfacing film of claim 8, wherein the primary polyisocyanate comprises hexamethylene diisocyanate.

10. The surfacing film of claim 1, wherein the base layer comprises a thermoplastic polyurethane.

11. The surfacing film of claim 10, wherein the thermoplastic polyurethane has a hard segment content of from 10 percent to 65 percent.

12. The surfacing film of claim 1, wherein the base layer further comprises from 1 percent to 20 percent of a colorant.

13. The surfacing film of claim 1, wherein the adhesive layer is either a pressure sensitive adhesive layer or a hot melt adhesive layer.

14. A process of making a surfacing film comprising:
initiating a curing reaction between a polyisocyanate and a hydroxy-functional fluoropolymer to provide an outer layer of the surfacing film, the outer layer comprising a fluoropolyurethane;
optionally, disposing onto the outer layer a primer layer comprising a polyurethane; and
disposing onto either the outer layer or the primer layer a base layer,
wherein the outer layer is less than functionally cured when the base layer or the primer layer is disposed thereon.

15. The process of claim 14, wherein the outer layer is from 30 percent to 90 percent cured at its surface when the base layer or the primer layer is disposed thereon.
